(19) United States
(12) Patent Application Publication
(10) Pub. No.: US 2009/0071373 A1
(43) Pub. Date: Mar. 19, 2009

(54) Method of producing organic particles

(76) Inventors: Yasuyuki Izumi, Kanagawa (JP); Yousuke Miyashita, Kanagawa (JP)

Correspondence Address: BIRCH STEWART KOLASCH & BIRCH, PO BOX 747, FALLS CHURCH, VA, 22040-0747, US

(21) Appl. No.: 11/919,988

(22) PCT Filed: May 8, 2006
(86) PCT No.: PCT/JP2006/309269

§ 371 Date: Nov. 6, 2007

(30) Foreign Application Priority Data
May 9, 2005 (JP) 2005-136747
Jul. 22, 2005 (JP) 2005-213503

(51) Int. Cl. C09B 67/20

(52) U.S. Cl. 106/493; 106/499

(57) ABSTRACT

A method of producing organic particles, which contains dissolving an organic material into a good solvent to form a solution, and mixing the solution with a poor solvent for the organic material, in which the poor solvent is compatible with the good solvent, to form particles of the organic material in a liquid mixture, in which at least one selected from the group consisting of an anionic surfactant having 14 or more carbon atoms (dispersing agent A) and a specific compound having an azo group (dispersing agent B) is contained in the liquid mixture in which the organic particles are formed.

### TECHNICAL FIELD

The present invention relates to a method of producing organic particles. In particular, the present invention relates to a method of producing organic particles that show excellent monodispersity and controlled particle diameters. Further, the present invention relates to a method of producing organic particles by a liquid phase method using a dispersing agent.

### BACKGROUND ART

In recent years, studies to reduce the size of particles have progressed. In particular, an intensive study has been conducted to reduce the particles into nanometer size (for example, in the range of 10 to 100 nm) which can hardly be realized by methods of pulverization, precipitation, and others. Further, attempts have been made not only to provide particles of a nanometer order, but also to provide them with excellent monodispersity (the term “monodispersity” employed in the present specification refers to the degree of uniformity of size of particle diameters dispersed).

Such nanometer-sized fine particles are distinguished from vigorously bulk particles (bigger in size) and from molecules and atoms (smaller in size). That is, the nanometer-size fine particles are categorized in a new field between them stated above in size. Thus, such nanoparticles are considered to show unexpected new properties over the conventional sized particles. It is also possible to stabilize the properties of nanoparticles if the monodispersity can be improved. Thus, nanoparticles having such potential are attracting attention in various fields, and they have been studied vigorously in a variety of fields such as biochemistry, new materials, electronic elements, light-emitting display devices, printing, and medicine.

In particular, organic nanoparticles made of an organic compound involve great potential as a functional material, because the organic compounds, per se, can be modified diversely. For example, polyimide has been utilized in various fields because of, for example, the following reasons: polyimide is a chemically and mechanically stable material owing to, for example, its heat resistance, solvent resistance, and mechanical characteristics, and is excellent in electrical insulating property. A material obtained by turning polyimide into fine particles has been used in a wide variety of new applications by virtue of the combination of the properties and shape of polyimide. For example, as a technical proposal, polyimide having a fine-particle shape is proposed for use as an additive in a powder toner for image formation (see, for example, JP-A-11-237760 (“JP-A” means unexamined published Japanese patent application)).

In addition, among the organic nanoparticles, organic pigments are used in such applications as painting, a printing ink, an electrophotographic toner, an inkjet ink, and a color filter, and thus the organic pigments are now important materials essential for our everyday life. Particularly, organic pigments are demanded in high-performance with practical importance including pigments for an inkjet ink and a color filter.

Dyes have been used as the colorants for inkjet inks, but pigments are employed recently for solving problems of the dyes in water resistance and light stability. Images obtained by using a pigment ink have an advantage that they are superior in light stability and water resistance to the images formed by using a dye-based ink. However, it is difficult to give fine particles having high monodispersity and having nanometer size, so that the pigment particles can penetrate into the pores on paper surface. As a result, such an image has a problem that the adhesiveness thereof to paper is weaker.

Further, the increase in the number of pixels of a digital camera, there is increased need for reduction in thickness of the color filter for use in optical elements such as a CCD sensor and a display device. Organic pigments have been used in color filters, of which thickness depends significantly on the particle diameter of the organic pigment, and hence it is needed to produce fine particles in a nanometer size, with having stability in a monodispersed state. Further, the optical characteristics of pigments to be used for ink-jet ink and a color filter is improved as the particle diameter of the pigments reduces, but the light resistance of the pigments is considered to be deteriorated in association with the reduction of pigment particle diameter. A new technique is thus desired to form particles in a nanometer size under control of the particle diameter, with maintaining the monodispersity.

As for production methods of organic nanoparticles, studies are made on, for example, a gas-phase method (a method of sublimating a sample under inert gas atmosphere and depositing particles on a substrate), a liquid-phase method (a reprecipitation method for obtaining fineparticles by injecting a sample dissolved in a good solvent into a poor solvent of which the agitating condition and the temperature are controlled), and a laser-ablation method (a method of reducing the size of particles by laser-ablation of a sample dispersed in a solution with laser). There are also reports on preparation of monodispersed nanoparticles having a desired particle size by these methods (see JP-T-2002-092700 (“JP-T” means published searched patent publication), JP-A-6-79168, JP-A-2004-91560, and others).

Of those, the reprecipitation method has been attracting attention because it is a method of producing organic particles excellent in its simplicity and productivity. However, the method has not achieved yet the control of the particle diameters of the particles while maintaining the monodispersity of the particles. JP-T-2002-092700 describes that the particle diameter of organic particles changes depending on the temperature of a poor solvent which is used in the course of production of the organic particles. Although the particle diameter of the organic particles can be changed with the method, the monodispersity of the particles also changes.

### DISCLOSURE OF INVENTION

The problem to be solved in the present invention is to provide a method of producing organic particles. Further, the problem to be solved in the present invention is to provide a method of producing by control organic particles having a desired particle diameter, in a wide range of diameter in accordance with the reprecipitation method, with maintaining excellent monodispersity of the particles. The objects of the present invention have been attained by the following means:

(1) A method of producing organic particles, which comprises:

dissolving an organic material into a good solvent to form a solution; and

mixing the solution with a poor solvent for the organic material, in which the poor solvent is compatible with the good solvent, to form organic particles of the organic material in a liquid mixture,

wherein at least one selected from the group consisting of dispersing agent A and dispersing agent B is contained in the liquid mixture in which the organic particles are formed:

dispersing agent A: an anionic surfactant having 14 or more carbon atoms, and
dispersing agent B: a compound represented by formula (I), wherein A represents a component capable of forming an azo dye together with the X—Y; X represents a single bond or a group represented by —X¹—X²—; X¹ represents an arylene group having 6 to 20 carbon atoms; X² represents a divalent linking group selected from the group consisting of —CO—, —NR^{C}— (R^{C} represents an alkyl group having 1 to 5 carbon atoms, or a hydrogen atom), —O—, —S—, —SO—, —SO₂—, and a combination obtained from these groups; the arylene group represented by X¹ may be further substituted; Y represents a group represented by —Y¹—(Y²—Y³—NR₂)ₐ; Y¹ represents a divalent or trivalent aromatic group having 6 to 20 carbon atoms; Y² represents a group having the same meaning as that of X²; Y³ represents —{C(R¹¹)(R¹²)}ₖ—; R¹¹ and R¹² each represent a hydrogen atom or an alkyl group having 1 to 5 carbon atoms; k represents an integer of 1 to 10; the aromatic group represented by Y¹ may be further substituted; —NR₂ represents a lower alkylamino group, or a five- or six-membered saturated heterocyclic ring containing a nitrogen atom; and a represents 1 or 2.

A-N═N—X—Y [Chemical formula 1]

Formula (I)

(2) The method of producing organic particles as described in the above item (1), wherein the organic particles have a number average particle diameter of 1 μm or less.
(3) The method of producing organic particles as described in the above item (1) or (2), wherein the poor solvent for the organic material is a solvent selected from the group consisting of an aqueous solvent, an alcohol compound solvent, a ketone compound solvent, an ether compound solvent, an ester compound solvent, and a mixture of these solvents.
(4) The method of producing organic particles as described in any one of the above items (1) to (3), wherein the good solvent for the organic material is a solvent selected from the group consisting of an aqueous solvent, an alcohol compound solvent, a ketone compound solvent, an ether compound solvent, a sulfoxide compound solvent, an ester compound solvent, an amide compound solvent, and a mixture of these solvents.
(5) The method of producing organic particles as described in any one of the above items (1) to (4), wherein the dispersing agent is contained in each or both of the solvents which are used for forming the organic particles.
(6) The method of producing organic particles as described in any one of the above items (1) to (5), wherein the organic particles are organic pigment particles.
(7) The method of producing organic particles as described in any one of the above items (1) to (6), wherein the at least one dispersing agent is a dispersing agent selected from the dispersing agent A, and wherein at least one of the selected dispersing agent has no oxyethylene chain.

Other and further features and advantages of the invention will appear more fully from the following description, appropriately referring to the accompanying drawings.

### BEST MODE FOR CARRYING OUT THE INVENTION

Hereinafter, a method of producing organic particles of the present invention will be described in detail. It should be noted that organic particles to be formed by the producing method of the present invention may be crystalline particles, amorphous particles, or a mixture of these particles.

For an organic material to be used in the method of producing organic particles of the present invention, there is no particular limitation as long as the organic material can be formed into organic particles by a reprecipitation method. Examples of the organic material include an organic pigment, an organic dye, fullerene, a polymer compound such as polydiacetylene and polyimide, and an aromatic hydrocarbon or an aliphatic hydrocarbon (e.g. an aromatic hydrocarbon or aliphatic hydrocarbon having orientation, or an aromatic hydrocarbon or aliphatic hydrocarbon having sublimation property). Of those, an organic pigment, an organic dye, or a polymer compound is preferable; and an organic pigment is particularly preferable. In addition, two or more of them may be used in combination.

The organic pigment is not limited in the color tone thereof. Specifically, examples thereof include a perylene, perynone, quinacridone, quinacridonequinone, anthraquinone, anthanthrone, benzimidazolone, condensed disazo, disazo, azo, indanthrone, phthalocyanine, triaryl carbonium, dioxazine, aminoanthraquinone, diketopyrrolopyrrole, thioindigo, isoindoline, isoindolinone, pyranthrone or isoviolanthrone-compound pigment, or a mixture thereof.

More specifically, examples of the organic pigment include perylene-compound pigments, such as C.I. Pigment Red 190 (C.I. No. 71140), C.I. Pigment Red 224 (C.I. No. 71127), C.I. Pigment Violet 29 (C.I. No. 71129), or the like; perynone-compound pigments, such as C.I. Pigment Orange 43 (C.I. No. 71105), C.I. Pigment Red 194 (C.I. No. 71100) or the like; quinacridone-compound pigments, such as C.I. Pigment Violet 19 (C.I. No. 73900), C.I. Pigment Violet 42, C.I. Pigment Red 122 (C.I. No. 73915), C.I. Pigment Red 192, C.I. Pigment Red 202 (C.I. No. 73907), C.I. Pigment Red 207 (C.I. Nos. 73900, 73906), C.I. Pigment Red 209 (C.I. No. 73905) or the like; quinacridonequinone-compound pigments, such as C.I. Pigment Red 206 (C.I. No. 73900/73920), C.I. Pigment Orange 48 (C.I. No. 73900/73920), C.I. Pigment Orange 49 (C.I. No. 73900/73920), or the like; anthraquinone-compound pigments, such as C.I. Pigment Yellow 147 (C.I. No. 60645) or the like; anthanthrone-compound pigments, such as C.I. Pigment Red 168 (C.I. No. 59300) or the like; benzimidazolone-compound pigments, such as C.I. Pigment Brown 25 (C.I. No. 12510), C.I. Pigment Violet 32 (C.I. No. 12517), C.I. Pigment Yellow 180 (C.I. No. 21290), C.I. Pigment Yellow 181 (C.I. No. 11777), C.I. Pigment Orange 62 (C.I. No. 11775), C.I. Pigment Red 185 (C.I. No. 12516), or the like; condensed disazo-compound pigments, such as C.I. Pigment Yellow 93 (C.I. No. 20710), C.I. Pigment Yellow 94 (C.I. No. 20038), C.I. Pigment Yellow 95 (C.I. No. 20034), C.I. Pigment Yellow 128 (C.I. No. 20037), C.I. Pigment Yellow 166 (C.I. No. 20035), C.I. Pigment Orange 34 (C.I. No. 21115), C.I. Pigment Orange 13 (C.I. No. 21110), C.I. Pigment Orange 31 (C.I. No. 20050), C.I. Pigment Red 144 (C.I. No. 20735), C.I. Pigment Red 166 (C.I. No. 20730), C.I. Pigment Red 220 (C.I. No. 20055), C.I. Pigment Red 221 (C.I. No. 20065), C.I. Pigment Red 242 (C.I. No. 20067), C.I. Pigment Red 248, C.I. Pigment Red 262, C.I. Pigment Brown 23 (C.I. No. 20060), or the like; disazo-compound pigments, such as C.I. Pigment Yellow 13 (C.I. No. 21100), C.I. Pigment Yellow 83 (C.I. No. 21108), C.I. Pigment Yellow 188 (C.I. No. 21094), or the like; azo-compound pigments, such as C.I. Pigment Red 187 (C.I. No. 12486), C.I. Pigment Red 170 (C.I. No. 12475), C.I. Pigment Yellow 74 (C.I. No. 11714), C.I. Pigment Yellow 150 (C.I. No. 48545), C.I. Pigment Red 48 (C.I. No. 15865), C.I. Pigment Red 53 (C.I. No. 15585), C.I. Pigment Orange 64 (C.I. No. 12760), C.I. Pigment Red 247 (C.I. No. 15915), or the like; indanthrone-compound pigments, such as C.I. Pigment Blue 60 (C.I. No. 69800), or the like; phthalocyanine-compound pigments, such as C.I. Pigment Green 7 (C.I. No. 74260), C.I. Pigment Green 36 (C.I. No. 74265), Pigment Green 37 (C.I. No. 74255), Pigment Blue 16 (C.I. No. 74100), C.I. Pigment Blue 75 (C.I. No. 74160:2), 15 (C.I. No. 74160), or the like; triaryl carbonium-compound pigments, such as C.I. Pigment Blue 56 (C.I. No. 42800), C.I. Pigment Blue 61 (C.I. No. 42765:1), or the like; dioxazine-compound pigments, such as C.I. Pigment Violet 23 (C.I. No. 51319), C.I. Pigment Violet 37 (C.I. No. 51345), or the like; aminoanthraquinone-compound pigments, such as C.I. Pigment Red 177 (C.I. No. 65300), or the like; diketopyrrolopyrrole-compound pigments, such as C.I. Pigment Red 254 (C.I. No. 56110), C.I. Pigment Red 255 (C.I. No. 561050), C.I. Pigment Red 264, C.I. Pigment Red 272 (C.I. No. 561150), C.I. Pigment Orange 71, C.I. Pigment Orange 73, or the like; thioindigo-compound pigments, such as C.I. Pigment Red 88 (C.I. No. 73312), or the like; isoindoline-compound pigments, such as C.I. Pigment Yellow 139 (C.I. No. 56298), C.I. Pigment Orange 66 (C.I. No. 48210), or the like; isoindolinone-compound pigments, such as C.I. Pigment Yellow 109 (C.I. No. 56284), C.I. Pigment Orange 61 (C.I. No. 11295), or the like; pyranthrone-compound pigments, such as C.I. Pigment Orange 40 (C.I. No. 59700), C.I. Pigment Red 216 (C.I. No. 59710), or the like; or isoviolanthrone-compound pigments, such as C.I. Pigment Violet 31 (C.I. No. 60010), or the like.

In the method of producing organic particles of the present invention, a mixture of two or more organic pigments, a solid solution of organic pigments, or a combination thereof may also be used.

Examples of the organic dye include an azo dye, a cyanine dye, a merocyanine dye, and a coumarin dye. Examples of the polymer compound include polydiacetylene and polyimide.

As to a particle diameter of the organic pigment particles, an average scale of a group can be evaluated by several measurement methods. There are frequently-used parameters such as mode diameter indicating the maximum value of distribution, median diameter corresponding to the median value in the integral frequency distribution curve, and various average diameters (number-averaged diameter, length-averaged diameter, area-averaged diameter, weight-averaged diameter, volume-averaged diameter, or the like), and the like. In the present invention, the particle diameter means a number-averaged diameter, unless otherwise particularly specified. The average particle diameter of the organic particles (primary particles) contained in the organic particle dispersion used in the method of producing organic particles according to the present invention is preferably 500 μm or less, more preferably 100 μm or less, and particularly preferably 10 μm or less. Further, in case of preparing nano-meter-size nano-particles, the average particle diameter is preferably 1 nm to 1 μm, more preferably 1 to 200 nm, further preferably 2 to 100 nm, and particularly preferably 5 to 80 nm.

Further, in the present invention, a ratio (Mv/Mn) of volume-averaged diameter (Mv) to number-averaged diameter (Mn) is used as the indicator of the degree of monodispersion of particles uniform in size, unless otherwise particularly specified. The monodispersity, that is the ratio Mv/Mn, of the particles (primary particles) contained in the organic particle dispersion used in the method of producing organic particles of the present invention is preferably 1.0 to 2.0, more preferably 1.0 to 1.8, and particularly preferably 1.0 to 1.5.

Examples of a method of determining the particle diameter of the organic particles include a microscopic method, a gravimetric method, a light scattering method, a light shielding method, an electric resistance method, an acoustic method, and a dynamic light scattering method. Among these, the microscopic method and the dynamic light scattering method are particularly preferable. Examples of a microscope to be used in the microscopic method include a scanning electron microscope (for example, the average particle diameter of organic particles can be determined by drying the dispersion of the organic particles on filter paper, by photographing the particles with the scanning electron microscope, and by measuring the particle diameter of each of the particles in the photograph with a vernier caliper) and a transmission electron microscope. Examples of a particle measuring device according to the dynamic light scattering method include Nanotrac UPA-EX 150 (trade name) manufactured by NIKKISO Co., Ltd., and a dynamic light scattering photometer DLS-7000 series (trade name) manufactured by OTSUKA ELECTRONICS CO., LTD.

Next, the poor solvent to be used in the method of producing organic particles of the present invention will be described.

For the poor solvent, there is no particular limitation as long as the poor solvent does not dissolve an organic material to be used, and the poor solvent is compatible or uniformly mixed with the good solvent to be used at the time of the production of the organic particles. With respect to the poor solvent for the organic material, the solubility of the organic material in the poor solvent is preferably 0.02 mass % or less, more preferably 0.01 mass % or less. The solubility of the organic material in the poor solvent has no particular lower limit, but it is practical that the solubility is 0.000001 mass % or more in consideration of an organic material ordinarily used. The solubility may be solubility in the case where the organic material is dissolved in the presence of an acid or an alkali. In addition, compatibility or uniform mixing property between the good solvent and the poor solvent is such that the solubility of the good solvent in the poor solvent is preferably 30 mass % or more, more preferably 50 mass % or more.

Examples of the poor solvents include aqueous solvents (e.g., water, aqueous hydrochloric acid solution, and aqueous sodium hydroxide solution), alcohol compound solvents, ketone compound solvents, ether compound solvents, aromatic compound solvents, carbon disulfide solvents, aliphatic compound solvents, nitrile compound solvents, halogen compound solvents, ester compound solvents, ionic solvents, and mixed solvents thereof. Preferable example of the poor solvents include aqueous solvents, alcohol compound solvents, ketone compound solvents, ether compound solvents, ester compound solvents and mixed solvents thereof; and more preferable example of the poor solvents include aqueous solvents, alcohol compound solvents and ester compound solvents.

Examples of the alcohol compound solvents include methanol, ethanol, isopropyl alcohol, n-propyl alcohol, 1-methoxy-2-propanol, and the like. Examples of the ketone compound solvents include acetone, methylethylketone, methylisobutylketone, cyclohexanone, and the like. Examples of ether compound solvents include dimethylether, diethylether, tetrahydrofuran and the like. Examples of the aromatic compound solvents include benzene, toluene, and the like. Examples of the aliphatic compound solvents include hexane, and the like. Examples of the nitrile compound solvents include acetonitrile, and the like. Examples of the halogen compound solvents include dichloromethane, trichloroethylene, and the like. Examples of the ester compound solvents include ethyl acetate, ethyl lactate, 2-(1-methoxy) propyl acetate, and the like. Examples of the ionic solvents include a salt of 1-butyl-3-methylimidazolium and PF₆⁻, and the like.

Next, the good solvent to be used in the method of producing organic particles of the present invention will be described.

For the good solvent, there is no particular limitation as long as it can dissolve the organic material to be used, and the good solvent is compatible or uniformly mixed with the poor solvent to be used at the time of the production of the organic particles. With respect to the solubility of the organic material in the good solvent, the solubility of the organic material is preferably 0.2 mass % or more, and more preferably 0.5 mass % or more. The solubility of the organic material in the good solvent has no particular upper limit, but it is practical that the solubility is 50 mass % or less in consideration of an organic material to be ordinarily used. The solubility may be solubility in the case where the organic material is dissolved in the presence of an acid or an alkali. A preferable range for compatibility or uniform mixing property between the poor solvent and the good solvent is as described above.

Examples of the good solvents include aqueous solvents (e.g., water, aqueous hydrochloric acid solution, and aqueous sodium hydroxide solution), alcohol compound solvents, amide compound solvents, ketone compound solvents, ether compound solvents, aromatic compound solvents, carbon disulfide solvents, aliphatic compound solvents, nitrile compound solvents, sulfoxide compound solvents, halogen compound solvents, ester compound solvents, ionic solvents, the mixed solvents thereof, and the like. Among these, aqueous solvents, alcohol compound solvents, ketone compound solvents, ether compound solvents, sulfoxide compound solvents, ester compound solvents, amide compound solvents, and the mixed solvents thereof are preferable; aqueous solvents, alcohol compound solvents, ester compound solvents, sulfoxide compound solvents, and amide compound solvents are more preferable; aqueous solvents, sulfoxide compound solvents, and amide compounds solvents are further preferable; and sulfoxide compound solvents and amide compounds solvents are particularly preferable. Examples of the amide compound solvents include N,N-dimethylformamide, 1-methyl-2-pyrrolidone, 2-pyrrolidinone, 1,3-dimethyl-2-imidazolidinone, 2-pyrrolidinone, ε-caprolactam, formamide, N-methylformamide, acetamide, N-methylacetamide, N,N-dimethylacetamide, N-methylpropaneamide, and hexamethylphosphoric triamide.

In addition, the concentration of the organic material solution prepared by dissolving the organic material in the good solvent is preferably in the range of from the saturation concentration of the organic material with respect to the good solvent under a condition at the time of the dissolution to about one hundredth of the saturation concentration. The concentration is preferably, for example, 0.5 to 12 mass %, though the preferable value varies depending on the organic material to be used.

The condition under which the organic material solution is prepared is not particularly restricted, and can be selected from a range from a normal pressure condition to a subcritical or supercritical condition. The temperature at which the solution is prepared under normal pressure is preferably −10 to 150° C., more preferably −5 to 130° C., and particularly preferably 0 to 100° C.

For a condition for the poor solvent at the time of the production of the organic particles, there is no particular limitation, and the condition can be selected from a range from a normal pressure condition to a subcritical or supercritical condition. The temperature at the time of preparation under normal pressure is preferably −30 to 100° C., more preferably −10 to 60° C., and particularly preferably 0 to 30° C.

A method of mixing the organic material solution and the poor solvent is not particularly restricted; but it is preferable to add one of them to the other while being stirred, and it is particularly preferable to add the organic material solution to the poor solvent while being stirred. A pump or the like may be or may not be used for adding. As the adding method, addition to the stirred liquid or addition from outside the stirred liquid may be used; addition to the stirred liquid is preferable.

The stirring rate for stirring one of them is preferably 100 to 10,000 rpm, more preferably 150 to 8,000 rpm, and particularly preferably 200 to 6,000 rpm.

A mixing ratio of the organic material solution to the poor solvent (good solvent/poor solvent ratio) is preferably 1/50 to 2/3, more preferably 1/40 to 1/2, and particularly preferably 1/20 to 3/8, in volume ratio.

For the concentration of the mixed liquid after the preparation of the organic particles (which is also referred to as “organic particles liquid” or “organic particles dispersion”), there is no particular limitation as long as the organic particles can be dispersed, but the organic particles is dispersed in an amount of preferably 10 to 40,000 mg, more preferably 20 to 30,000 mg, and particularly preferably 50 to 25,000 mg, with respect to 1,000 ml of the dispersing solvent.

Next, the dispersing agent to be used in the method of producing organic particles of the present invention will be described.

At least one selected from the dispersing agent group consisting of dispersing agent A and dispersing agent B described below is used as the dispersing agent in the method of producing organic particles of the present invention.

The dispersing agent A is an anionic dispersing agent (anionic surfactant) having 14 or more carbon atoms. Specific examples thereof include an N-acyl-N-alkyltaurine salt, an aliphatic acid salt, an alkyl sulfate, an alkylbenzene sulfonate, an alkylnaphthalene sulfonate, a dialkyl sulfosuccinate, an alkyl phosphate, a naphthalene sulfonic acid-formal in condensate, and a polyoxyethylene alkyl sulfate.

Examples of the N-acyl-N-alkyltaurine salt include those described in, for example, JP-A-3-273067. Examples of the aliphatic acid salt include sodium salts, potassium salts, ammonium salts, and triethanolamine salts of aliphatic acids such as myristic acid, palmitic acid, stearic acid, oleic acid, linoleic acid, linolenic acid, and ricinoleic acid. Examples of the alkyl sulfate include triethanolamine lauryl sulfate, sodium myristyl sulfate, sodium cetyl sulfate, sodium oleyl sulfate, and ammonium oleyl sulfate. Examples of the alkylbenzene sulfonate include sodium salts, ammonium salts, triethanolamine salts, and calcium salts of dodecylbenzenesulfonic acid; and sodium salts, triethanolamine salts, and calcium salts of pentadecylbenzenesulfonic acid. Examples of the alkylnaphthalene sulfonate include sodium sesquibutylnaphthalene sulfonate and sodium diisopropylnaphthalene sulfonate. Examples of the dialkyl sulfosuccinate include sodium dioctyl sulfosuccinate, sodium dihexyl sulfosuccinate, sodium dicyclohexyl sulfosuccinate, sodium diamyl sulfosuccinate, and sodium ditridecyl sulfosuccinate. Examples of the alkyl phosphate include sodium salts, potassium salts, ammonium salts, and triethanolamine salts of an alkyl monophosphate and of an alkyl triphosphate. Example of the naphthalene sulfonic acid-formalin condensate is formalin condensates of sodium naphthalenesulfonate. Examples of the polyoxyethylene alkyl sulfate include: sodium salts, ammonium salts, and triethanolamine salts of polyoxyethylene (2) dodecyl sulfate; and sodium salts, ammonium salts, and triethanolamine salts of polyoxyethylene (3) dodecyl sulfate.

The concentration of the anionic dispersing agent having 14 or more carbon atoms in the organic particles dispersion is preferably 0.01 to 20, more preferably 0.1 to 15, and particularly preferably 0.5 to 10, when the mass of the organic material in the dispersion is set to 1. In addition, the preferable range for the content of the dispersing agent is applicable also to that of the dispersing agent B to be described later.

The number of carbon atoms in the anionic dispersing agent is 14 or more. The number of carbon atoms is preferably 14 to 40, and more preferably 14 to 36. In the case of the naphthalene sulfonic acid-formalin condensate, the number of carbon atoms has preferably 21 to 200 carbon atoms, and more preferably 21 to 100 carbon atoms. An anionic dispersing agent having an excessively small number of carbon atoms shows a weak affinity for the organic material, so a controlling effect on a particle diameter (to obtain particles having improved monodispersity and target particle diameters covering a wide range) cannot be obtained.

The dispersing agent B is a compound having an azo group represented by the following formula (I). In formula (I), A represents a component capable of forming an azo dye together with the X—Y, X represents a single bond or a group represented by —X¹—X²—, X¹ represents an arylene group (an arylene group having 6 to 20 carbon atoms, and examples thereof include a 1,2-phenylene group, a 1,3-phenylene group, a 1,4-phenylene group, a 1,4-naphthylene group, and a 1,5-naphthylene group), and X² represents a divalent linking group selected from the group consisting of —CO—, —NR^{C}— (R^{C} represents an alkyl group having 1 to 5 carbon atoms, or a hydrogen atom), —O—, —S—, —SO—, —SO₂—, and a combination obtained from these groups. The arylene group represented by X¹ may be further substituted. X preferably represents a single bond or a group selected from divalent linking groups represented by the following formulae X1 to X5.

A-N═N—X—Y [Chemical formula 2]

Formula (I)

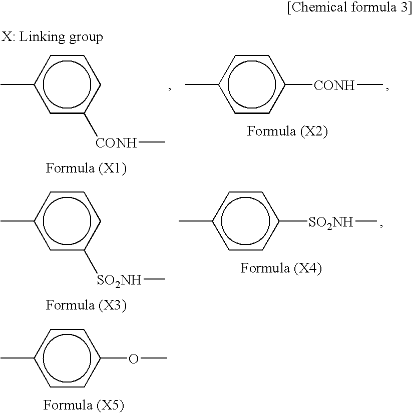

Examples of the component A include the following ones.

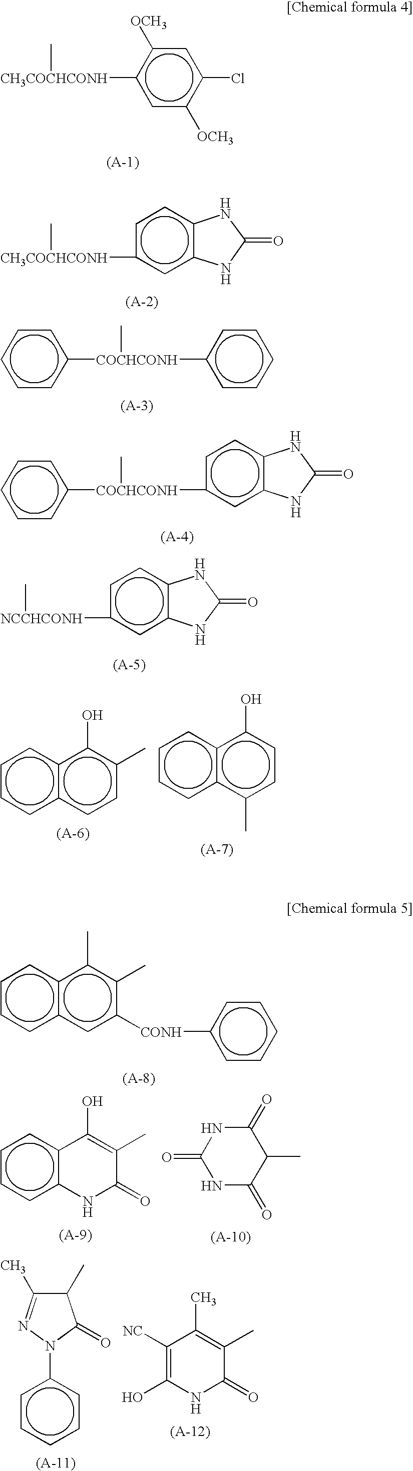

In formula (I), Y represents a group represented by —Y¹(Y²—Y³—NR₂)ₐ, Y¹ represents a divalent or trivalent aromatic group (having 6 to 20 carbon atoms), Y² represents a group having the same meaning as that of X², Y³ represents —{C(R¹¹)(R¹²)}ₖ—, R¹¹ and R¹² each represent a hydrogen atom or an alkyl group having 1 to 5 carbon atoms, and k represents an integer of 1 to 10. The aromatic group represented by Y¹ may be further substituted. Y preferably represents a group represented by the following formula (II). In formula (II), Z represents a lower alkylene group; —NR₂ represents a lower alkylamino group, or a five- or six-membered saturated heterocyclic ring containing a nitrogen atom; and a represents 1 or 2.

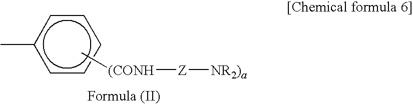

Z can be represented as —(CH₂)_{b}—, in which b represents an integer of 1 to 5, preferably 2 or 3. —NR₂ represents a lower alkylamino group, or a five- or six-membered saturated heterocyclic ring containing a nitrogen atom. When —NR₂ represents a lower alkylamino group, —NR₂ can be represented as —N(CₙH₂ₙ₊₁)₂, in which n represents an integer of 1 to 4, preferably 1 or 2. On the other hand, when —NR₂ represents a five- or six-membered saturated heterocyclic ring containing a nitrogen atom, the heterocyclic ring is preferably a heterocyclic ring represented by the following structural formulas.

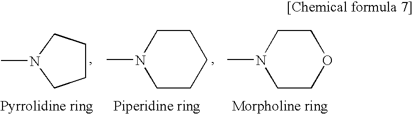

Specific examples of the compound represented by formula (I) are shown below, but the present invention is not limited to these examples.

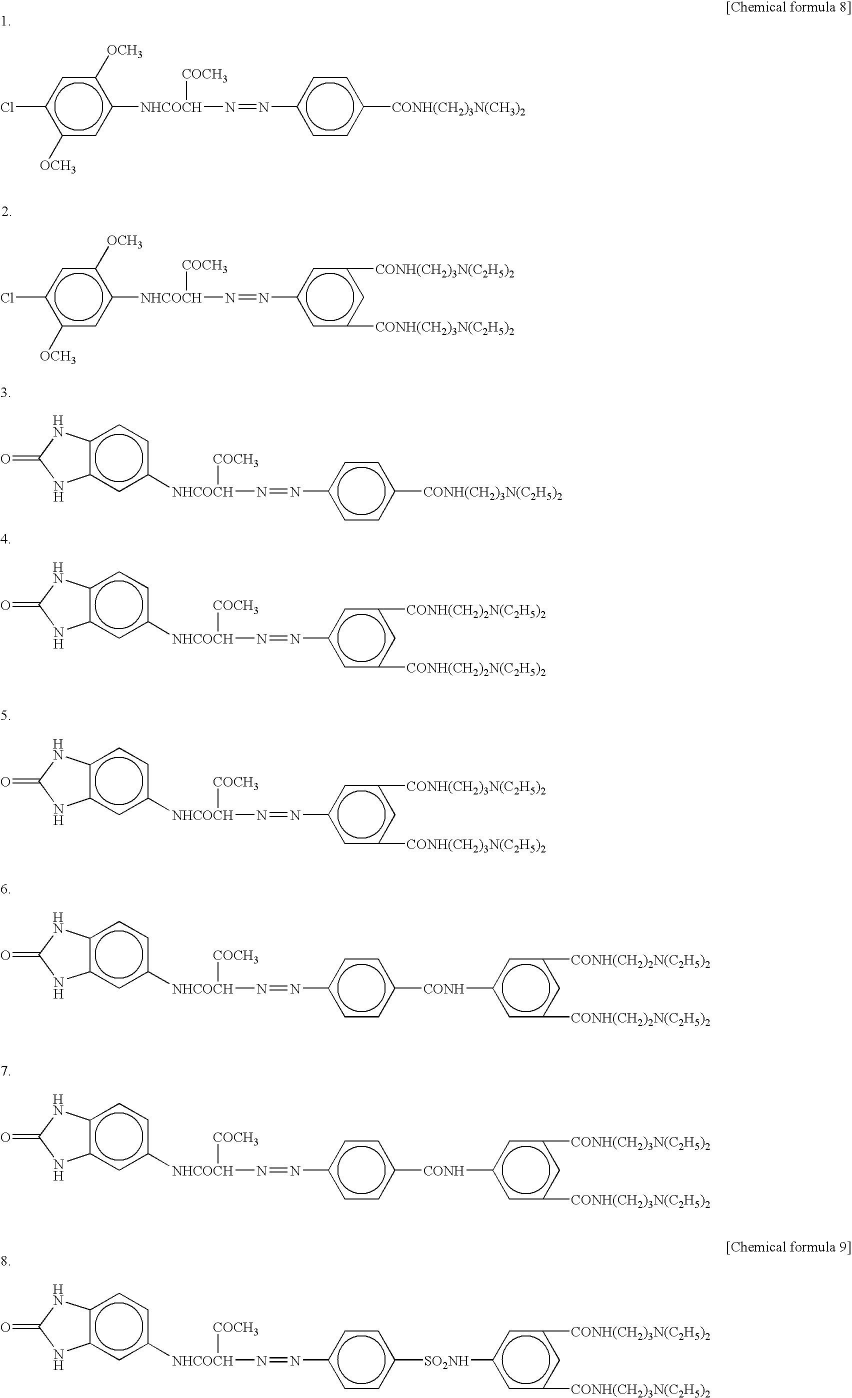

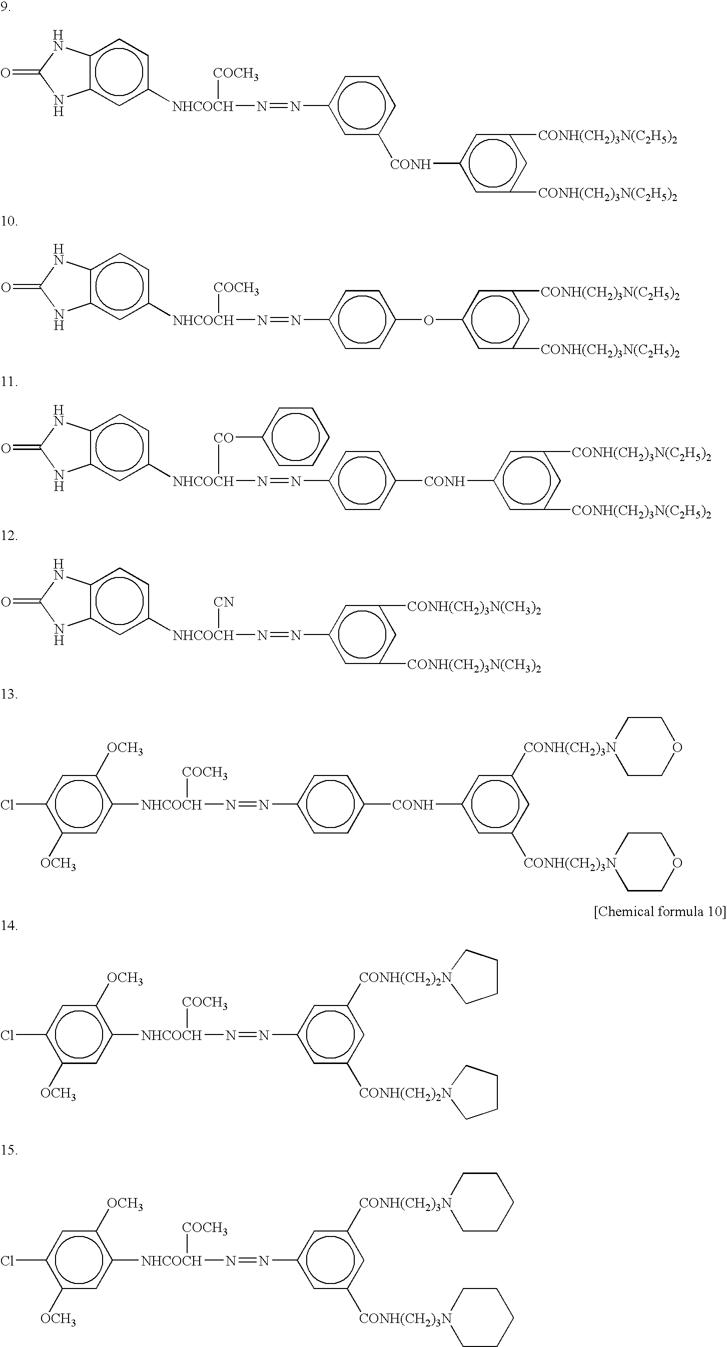

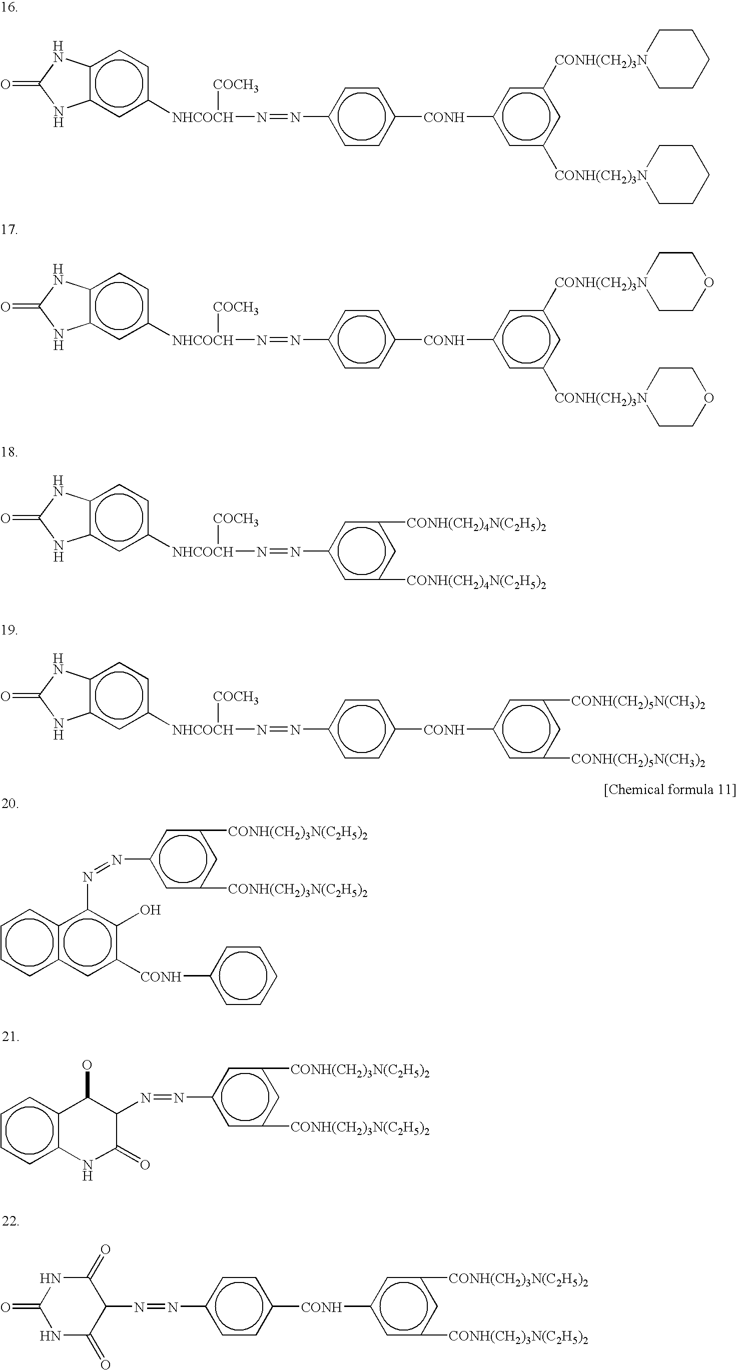

The compound represented by formula (I) has a pigment parent nucleus and a nitrogen atom, so the compound is expected to show a high affinity for the organic material and to have a controlling effect on the particle diameter.

An improvement in monodispersity and particle diameter control will be described in more detail. In the method of producing organic particles of the present invention, incorporating at least one selected from the group consisting of the above-described dispersing agent A and dispersing agent B into the mixed liquid in which the organic particles are formed (preferably coexisting the above dispersing agent at the time of the formation of the organic particles) enables the formation of monodisperse organic particles showing a sharp particle diameter distribution peak. Moreover, adjusting the amount of the dispersing agent to be added makes it possible to obtain organic particles under control of the particle diameter in a wide range.

The range in which a particle diameter is controlled depending on the amount of the dispersing agent to be added is appropriately determined depending on the kind of the organic material; for example, the particle diameter can be controlled in the range of 10 to 100 nm. Specifically, an increase in amount of the dispersing agent can provide larger particles. Examples of a preferable controlling mode of the particle diameter include the following. In the case where a dispersing agent is contained in an organic material solution, when the amount of the dispersing agent to be added is set to 0.1 to 1 with the mass of an organic material in the organic material solution defined as 1, the particle diameters of particles obtained by using the dispersing agent can be one time to twice as large as the particle diameters of particles obtained without using the dispersing agent. Further, when the amount of the dispersing agent is increased to 1 to 2, particles having different particle diameters each of which is twice to four times as large as the particle diameter of each particle obtained without using the dispersing agent can be obtained without the deterioration of the monodispersity of the particles. In addition, in the case where the dispersing agent is contained in the poor solvent for the organic material, when the amount of the dispersing agent to be added is set to 0.5 to 10 with the mass of the organic material in the poor solvent defined as 1, the particle diameters of particles obtained by using the dispersing agent can be one time to twice as large as the particle diameters of particles obtained without using the dispersing agent. Further, when the amount of the dispersing agent is increased to 10 to 20, particles having different particle diameters each of which is twice to four times as large as the particle diameter of each particle obtained without using the dispersing agent can be obtained without the deterioration of the monodispersity of the particles.

Here, in the reprecipitation method, for example, the organic material solution is added to the poor solvent for the organic material, whereby the organic material solution is dispersed as a droplet in the poor solvent, and then the solvent of the organic material solution diffuses in the poor solvent so that organic particles may be formed. In the method of producing organic particles of the present invention, for example, the dispersing agent is made to coexist at the time of the formation of the organic particles, whereby the particle diameter can be controlled by changing the size of the droplet, and a good dispersed state can be obtained.

In the method of producing organic particles of the present invention, there is no particular limitation on the timing at which the dispersing agent, so far as the dispersing agent is contained in the mixed liquid in which the organic particles are formed. For example, the dispersing agent is preferably contained in the solvent(s) at the time of the formation of the organic particles. In this case, the dispersing agent may be added to the good solvent, or may be added to the poor solvent. The dispersing agent may be added in a powder form, or may be added in a solution form. For a solvent kind when the dispersing agent is added in a solution form, there is no particular limitation, and a solvent which can dissolve the dispersing agent and which is soluble in the good solvent or poor solvent to which the dispersing agent is added is preferable. For conditions for the dispersing agent solution at the time of addition, there is no particular limitation, and the conditions can be selected from a range from a normal pressure condition to a subcritical or supercritical condition. The temperature at which the solution is prepared under normal pressure is preferably −30 to 100° C., more preferably −20 to 95° C., and particularly preferably −10 to 90° C. The concentration of the dispersing agent solution is preferably 1 to 70 mass %, more preferably 2 to 65 mass %, and particularly preferably 3 to 60 mass %.

For conditions for the good solvent and the poor solvent at the time of the addition of the dispersing, there is no particular limitation, and the conditions can be selected from the range from a normal pressure condition to a subcritical or supercritical condition. The temperature at normal pressure is preferably −10 to 150° C., more preferably −5 to 130° C., and particularly preferably 0 to 100° C. The good solvent or the poor solvent at the time of the addition of the dispersing agent may be left standing, or may be stirred. The dispersing agent can be added while an ultrasonic wave is applied. Each of the solvents is stirred at a rotation rate of preferably 100 to 10,000 rpm, more preferably 150 to 8,000 rpm, and particularly preferably 200 to 6,000 rpm. When an ultrasonic wave is applied, the ultrasonic wave to be applied has a frequency of preferably 10 to 60 kHz, more preferably 13 to 50 kHz, and particularly preferably 15 to 45 kHz.

When the dispersion containing organic particles produced by the method of producing organic particles of the present invention is subjected to concentration, an organic particle dispersion suitable for a color filter coating liquid or for ink-jet ink can be produced on an industrial scale. Hereinafter, a method of concentration the dispersion liquid will be described. Examples of the concentration method include: a method involving adding an extraction solvent to an organic particle dispersion, and mixing the resultant, to concentrate and extract organic particles in the extraction solvent phase; a method involving filtrating through a filter or the like; centrifugal separation; the drying of the solvent under heat or reduced pressure; and a combination of these methods. The concentration of an organic particle liquid after concentration (which is also referred to as “organic particle-concentrated liquid”) is preferably 1 to 100 mass %, more preferably 5 to 100 mass %, and particularly preferably 10 to 100 mass %. In addition, a liquid in which organic particles are dispersed in a desired state may be prepared by, for example, adding a dispersing agent, such as a polymer compound, to the concentrated organic particle liquid.

For the extraction solvent for use in the process of concentrating and extracting, there is no particular limitation, but it is preferably a solvent that is substantially incompatible (immiscible) with the dispersion solvent of the organic particle dispersion (e.g., aqueous solvent) (In the present invention, the term “substantially incompatible” means that the compatibility is low, and the solvent is soluble preferably in an amount of 50 mass % or less, and more preferably 30 mass % or less. Although the amount of the extraction solvent to be dissolved in the dispersion solvent has no particular lower limit, it is practical that the amount is 1 mass % or more in consideration of the solubility of an ordinary solvent.), and that forms an interface after the extraction solvent is mixed with the dispersion solvent and left still. In addition, the extraction solvent is preferably a solvent that causes weak aggregation to such a degree that the organic particles can be redispersed in the extraction solvent. In the present invention, weak, redispersible aggregation means that aggregates can be redispersed without applying high shearing force such as by milling or high-speed agitation. Such a state is preferable, because it is possible to prevent strong aggregation that may change the particle size, and to swell the desirable organic particles with the extraction solvent. As the extraction solvents, ester compound solvents, alcohol compound solvents, aromatic compound solvents, and aliphatic compound solvents are preferable; ester compound solvents, aromatic compound solvents, and aliphatic compound solvents are more preferable; and ester compound solvents are particularly preferable.

Examples of the ester compound solvents include 2-(1-methoxy)propyl acetate, ethyl acetate, ethyl lactate, and the like. Examples of the alcohol compound solvents include n-butanol, isobutanol, and the like. Examples of the aromatic compound solvents include benzene, toluene, xylene, and the like. Examples of the aliphatic compound solvents include n-hexane, cyclohexane, and the like. The extraction solvent may be a pure solvent of one of the preferable solvents above, while it may be a mixed solvent of multiple solvents.

For an amount of the extraction solvent, there is no particular limitation, as long as the solvent can extract the organic particles, but an amount of the extraction solvent is preferably smaller than an amount of the organic particle dispersion liquid, considering extraction for concentration. When expressed by volume ratio, an amount of the extraction solvent to be added is preferably in the range of 1 to 100, more preferably in the range of 10 to 90, and particularly preferably in the range of 20 to 80, with respect to 100 of the organic particle dispersion. A too-large amount may results in elongation of the time for concentration, while a too-small amount may cause insufficient extraction and residual particles in the dispersion solvent.

After addition of the extraction solvent, it is preferably agitated and mixed well for sufficient mutual contact with the dispersion. Any ordinary used method may be used for agitation and mixing. For a temperature during addition and mixing of the extraction solvent, there is no particular limitation, but the temperature is preferably 1 to 100° C. and more preferably 5 to 60° C. Any apparatus may be used for addition and mixing of the extraction solvent as long as it can suitably carry out each step. For example, a separatory funnel-like apparatus may be used.

The resultant concentrated liquid may be further concentrated or separated by filtration or the like. Examples of an apparatus for filter filtration include a high-pressure filtration apparatus and a vacuum filtration apparatus. Preferable filters include nano-filter, ultra-filter and the like.

A centrifugal separator for use in the concentration of the organic particles by centrifugal separation may be an arbitrary device as long as the organic particles in the organic particle dispersion (or in the organic particle concentrated extract) can be sedimented. Examples of the centrifugal separator include a general-purpose device, a system having a skimming function (function with which a supernatant layer is sucked during the rotation of the system, to discharge to the outside of the system), and a continuous centrifugal separator for continuously discharging solid matter.

As the conditions for centrifugal separation, a centrifugal force (a value representing a ratio of an applied centrifugal acceleration to the gravitational acceleration) is preferably 50 to 10,000, more preferably 100 to 8,000, and particularly preferably 150 to 6,000. A temperature at the time of centrifugal separation is preferably −10 to 80° C., more preferably −5 to 70° C., and particularly preferably 0 to 60° C., though a preferable temperature varies depending on the kind of the solvent of the dispersion.

For a device for use in the concentration of the organic particles by drying under reduced pressure, there is no particular limitation as long as the solvent of the organic particle dispersion (or of the organic particle concentrated extract) can be evaporated. Examples of the device include a general-purpose vacuum drier and a general-purpose rotary pump, a device capable of drying a liquid under heat and reduced pressure while stirring the liquid, and a device capable of continuously drying a liquid by passing the liquid through a tube the inside of which is heated and reduced in pressure.

A temperature for drying under heat and reduced pressure is preferably 30 to 230° C., more preferably 35 to 200° C., and particularly preferably 40 to 180° C. A pressure for the above-mentioned reduced pressure is preferably 100 to 100,000 Pa, more preferably 300 to 90,000 Pa, and particularly preferably 500 to 80,000 Pa.

According to the method of producing organic particles of the present invention, organic particles having a desired particle size can be produced even when the particle size is a fine particle diameter of a nanometer size (for example, 10 to 100 nm). Accordingly, when the organic particles are used for ink-jet ink, the ink has a high optical density, is excellent in uniformity of an image surface, has high chroma, and is vivid. Further, when the organic particles are used for a color filter, the color filter has a high optical density, is excellent in uniformity of its surface, has high contrast, and can reduce the noise of an image.

In the method of producing organic particles of the present invention, a stirring machine, a dispersing machine, an ultrasonic wave irradiation device, or the like, can also be preferably used. Examples of the shape of the stirring blade of the stirring machine include a turbine blade, a screw blade, a faudler blade, a dissolver blade, and a stirring portion constituted of a turbine portion capable of rotating and an immobilized stator portion placed around the turbine portion with a slight gap. Examples of the dispersing machine include a sand mill, a ball mill, an attritor, and a roll mill. Examples of the ultrasonic wave irradiation machine include an ultrasonic homogenizer and an ultrasonic cleaner.

According to the method of producing organic particles of the present invention, organic particles can be obtained under control of forming them in a desired particle diameter in a wide range of diameter, with maintaining monodispersity of the particles. In addition, a stable organic particle dispersion can be obtained, in which the organic particles do not aggregate even when time has passed.

The organic particles produced by the producing method of the present invention show nearly no changes in their particle diameter and monodispersity even when they are turned into a concentrated liquid, so they can be suitably used as ink-jet ink or raw material fine particles of the ink, or a color filter coating liquid or raw material fine particles of the liquid.

### EXAMPLES

The present invention will be described in more detail based on the following examples, but the present invention is not limited thereto.

### Example 1

A pigment solution was prepared by dissolving 530 mg of a pigment (Pigment Red 254) and 8 ml of a 1-mol/l aqueous solution of sodium hydroxide in 100 ml of 1-methyl-2-pyrrolidone. Separately, 1,000 ml of a solution, which contained dispersing agent A1 in an amount shown in Table 1 and 8 ml of 1-mol/l hydrochloric acid, was prepared as a poor solvent. (In the table, the amount of the dispersing agent is represented in terms of concentration (mass %) as the content of the dispersing agent in a solvent dissolving the dispersing agent. The same rules are also applied to the subsequent tables.)

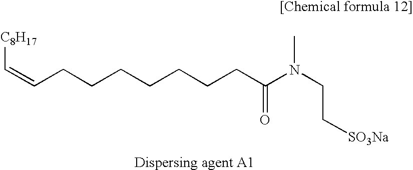

Here, a pigment particle dispersion was prepared by injecting all of the thus-prepared pigment solution at a flow rate of 50 ml/min with an NP-KX-500 type large-volume pulseless pump manufactured by Nihon Seimitsu Kagaku Co., Ltd. into the poor solvent. At this time, the poor solvent was stirred at 500 rpm with a GK-0222-10 type Ramond Stirrer manufactured by Fujisawa Pharmaceutical Co., Ltd., and the temperature was controlled at 1° C.

A primary particle diameter after the preparation was determined as follows: the dispersion was dried on filter paper, the resultant was photographed with a scanning electron microscope, and the number average particle diameter of 100 particles was determined. The ratio Mv/Mn as an index of monodispersity was determined with a Nanotrac UPA-EX 150 manufactured by NIKKISO CO., LTD. A value used as an index of a dispersion state was determined by: leaving the dispersion liquid standing for 1 week at room temperature; measuring the particle diameter with the Nanotrac after the leaving; and dividing the particle diameter after 1 week by the particle diameter immediately after the production of the pigment particles. Table 1 shows the results.

[Table 1]

TABLE 1

| Concentration | Particle | | | |
|---|---|---|---|---|
| of dispersing | diameter | | Dispersion | |
| agent A1 (mass %) | (nm) | Mv/Mn | state | Note |
| 0 | 20 | 1.4 | 10.1 | Comparative |
| | | | | example |
| 0.04 | 20 | 1.4 | 1.3 | This invention (1) |
| 0.1 | 25 | 1.3 | 1.0 | This invention (2) |
| 0.2 | 30 | 1.3 | 1.0 | This invention (3) |
| 0.4 | 35 | 1.4 | 1.0 | This invention (4) |
| 1.0 | 50 | 1.4 | 1.0 | This invention (5) |

### Example 2

A pigment solution was prepared by dissolving 530 mg of a pigment (Pigment Red 254) and 8 ml of a 1-mol/l aqueous solution of sodium hydroxide in 100 ml of 1-methyl-2-pyrrolidone. Separately, 1,000 ml of a solution, which contained sodium oleate in an amount shown in Table 2 and 8 ml of 1-mol/l hydrochloric acid, was prepared as a poor solvent.

Here, a pigment particle dispersion was prepared by injecting all of the thus-prepared pigment solution at a flow rate of 50 ml/min with an NP-KX-500 type large-volume pulseless pump manufactured by Nihon Seimitsu Kagaku Co., Ltd. into the poor solvent. At this time, the poor solvent was stirred at 500 rpm with a GK-0222-10 type Ramond Stirrer manufactured by Fujisawa Pharmaceutical Co., Ltd., and the temperature was controlled at 1° C.

Evaluation for each of the primary particle diameter, the ratio Mv/Mn, and the dispersion state was performed in the same manner as in Example 1. Table 2 shows the results.

[Table 2]

TABLE 2

| Concentration of | Particle | | | |
|---|---|---|---|---|
| sodium oleate | diameter | | Dispersion | |
| (mass %) | (nm) | Mv/Mn | state | Note |
| 0 | 20 | 1.4 | 10.1 | Comparative |
| | | | | example |
| 0.2 | 25 | 1.4 | 1.4 | This invention (6) |
| 1.0 | 45 | 1.4 | 1.2 | This invention (7) |

### Example 3

A pigment solution was prepared by dissolving 530 mg of a pigment (Pigment Red 254), 8 ml of a 1-mol/l aqueous solution of sodium hydroxide and dispersing agent B1 in an amount shown in Table 3 in 100 ml of 1-methyl-2-pyrrolidone.

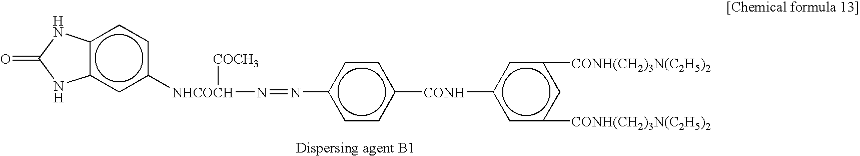

Separately, 1,000 ml of a solution, which contained 8 ml of 1-mol/l hydrochloric acid, was prepared as a poor solvent.

Here, a pigment particle dispersion was prepared by injecting all of the thus-prepared pigment solution at a flow rate of 50 ml/min with an NP-KX-500 type large-volume pulseless pump manufactured by Nihon Seimitsu Kagaku Co., Ltd. into the poor solvent. At this time, the poor solvent was stirred at 500 rpm with a GK-0222-10 type Ramond Stirrer manufactured by Fujisawa Pharmaceutical Co., Ltd., and the temperature was controlled at 1° C.

Evaluation for each of the primary particle diameter, the ratio Mv/Mn, and the dispersion state was performed in the same manner as in Example 1. Table 3 shows the results.

[Table 3]

TABLE 3

| Concentration of | Particle | | | |
|---|---|---|---|---|
| dispersing agent | diameter | | Dispersion | |
| B1 (mass %) | (nm) | Mv/Mn | state | Note |
| 0 | 20 | 1.4 | 10.1 | Comparative |
| | | | | example |
| 0.1 | 25 | 1.3 | 2.7 | This invention (8) |
| 0.5 | 35 | 1.3 | 2.4 | This invention (9) |

### Example 4

A pigment solution was prepared by dissolving 530 mg of a pigment (Pigment Red 254) and 8 ml of a 1-mol/l aqueous solution of sodium hydroxide in 100 ml of 1-methyl-2-pyrrolidone. Separately, 1,000 ml of a methanol solution, which contained dispersing agent AI in an amount shown in Table 4 and 8 ml of 1-mol/l hydrochloric acid, was prepared as a poor solvent.

Here, a pigment particle dispersion was prepared by injecting all of the thus-prepared pigment solution at a flow rate of 50 ml/min with an NP-KX-500 type large-volume pulseless pump manufactured by Nihon Seimitsu Kagaku Co., Ltd. into the poor solvent. At this time, the poor solvent was stirred at 500 rpm with a GK-0222-10 type Ramond Stirrer manufactured by Fujisawa Pharmaceutical Co., Ltd., and the temperature was controlled at 1° C.

Evaluation for each of the primary particle diameter, the ratio Mv/Mn, and the dispersion state was performed in the same manner as in Example 1. Table 4 shows the results.

[Table 4]

TABLE 4

| Concentration of | Particle | | | |
|---|---|---|---|---|
| surfactant | diameter | | Dispersion | |
| A1 (mass %) | (nm) | Mv/Mn | state | Note |
| 0 | 30 | 1.5 | 8.0 | Comparative |
| | | | | example |
| 0.2 | 45 | 1.5 | 2.2 | This invention (10) |
| 1.0 | 60 | 1.5 | 2.5 | This invention (11) |

### Example 5

A pigment solution was prepared by dissolving 530 mg of a pigment (Pigment Red 254) and 8 ml of a 1-mol/l aqueous solution of sodium hydroxide in 120 ml of 1-methyl-2-pyrrolidone. Separately, 1,000 ml of a 2-(1-methoxy)propylacetate solution, which contained dispersing agent AI in an amount shown in Table 5 and 8 ml of 1-mol/l hydrochloric acid, was prepared as a poor solvent. Here, a pigment particle dispersion was prepared by injecting all of the thus-prepared pigment solution at a flow rate of 50 ml/min with an NP-KX-500 type large-volume pulseless pump manufactured by Nihon Seimitsu Kagaku Co., Ltd. into the poor solvent. At this time, the poor solvent was stirred at 500 rpm with a GK-0222-10 type Ramond Stirrer manufactured by Fujisawa Pharmaceutical Co., Ltd., and the temperature was controlled at 1° C.

Evaluation for each of the primary particle diameter, the ratio Mv/Mn, and the dispersion state was performed in the same manner as in Example 1. Table 5 shows the results.

[Table 5]

TABLE 5

| Concentration of | Particle | | | |
|---|---|---|---|---|
| surfactant | diameter | | Dispersion | |
| A1 (mass %) | (nm) | Mv/Mn | state | Note |
| 0 | 30 | 1.5 | 8.3 | Comparative |
| | | | | example |
| 0.2 | 40 | 1.4 | 2.5 | This invention (12) |
| 1.0 | 55 | 1.5 | 2.2 | This invention (13) |

### Example 6

Using a solution prepared by mixing dimethyl sulfoxide (DMSO) and an 8-mol/l aqueous solution of potassium hydroxide at a weight ratio of 6:1, 100 ml of a pigment solution dissolving 150-mmol/l of a pigment (Pigment Red 254) was prepared.

Separately, 1,000 ml of a solution, which contained dispersing agent B1 in an amount shown in Table 6, was prepared as a poor solvent. Here, a pigment particle dispersion was prepared by injecting all of the thus-prepared pigment solution at a flow rate of 50 ml/min with an NP-KX-500 type large-volume pulseless pump manufactured by Nihon Seimitsu Kagaku Co., Ltd. into the poor solvent. At this time, the poor solvent was stirred at 500 rpm with a GK-0222-10 type Ramond Stirrer manufactured by Fujisawa Pharmaceutical Co., Ltd., and the temperature was controlled at 1° C. Evaluation for each of the primary particle diameter, the ratio Mv/Mn, and the dispersion state was performed in the same manner as in Example 1. Table 6 shows the results.

[Table 6]

TABLE 6

| Concentration of | Particle | | | |
|---|---|---|---|---|
| dispersing agent | diameter | | Dispersion | |
| B1 (mass %) | (nm) | Mv/Mn | state | Note |
| 0 | 20 | 1.4 | 9.7 | Comparative |
| | | | | example |
| 0.1 | 30 | 1.3 | 2.3 | This invention (14) |
| 0.5 | 35 | 1.3 | 2.3 | This invention (15) |

### Example 7

A pigment solution was prepared by dissolving 530 mg of a pigment (Pigment Red 254) and 8 ml of a 1-mol/l aqueous solution of sodium hydroxide in 100 ml of 1-methyl-2-pyrrolidone. Separately, 1,000 ml of a solution, which contained a dispersing agent having an oxyethylene chain, ELEMINOL RS-30, in an amount shown in Table 7 and 8 ml of 1-mol/l hydrochloric acid, was prepared as a poor solvent. Here, a pigment particle dispersion was prepared by injecting all of the thus-prepared pigment solution at a flow rate of 50 ml/min with an NP-KX-500 type large-volume pulseless pump manufactured by Nihon Seimitsu Kagaku Co., Ltd. into the poor solvent. At this time, the poor solvent was stirred at 500 rpm with a GK-0222-10 type Ramond Stirrer manufactured by Fujisawa Pharmaceutical Co., Ltd., and the temperature was controlled at 1° C.

Evaluation for each of the primary particle diameter, the ratio Mv/Mn, and the dispersion state was performed in the same manner as in Example 1. Table 7 shows the results.

TABLE 7

| Concentration of | Particle | | | |
|---|---|---|---|---|
| ELEMINOL | diameter | | Dispersion | |
| RS-30 (mass %) | (nm) | Mv/Mn | state | Note |
| 0 | 20 | 1.4 | 10.1 | Comparative |
| | | | | example |
| 0.1 | 24 | 1.5 | 2.9 | This invention (16) |
| 0.5 | 27 | 1.6 | 3.1 | This invention (17) |

### Comparative Example 1

A pigment solution was prepared by dissolving 530 mg of a pigment (Pigment Red 254) and 8 ml of a 1-mol/l aqueous solution of sodium hydroxide in 120 ml of 1-methyl-2-pyrrolidone. Separately, 1,000 ml of a solution, which contained sodium lauryl sulfate (SDS) in an amount shown in Table 8 and 8 ml of 1-mol/l hydrochloric acid, was prepared as a poor solvent.

Here, a pigment particle dispersion was prepared by injecting all of the thus-prepared pigment solution at a flow rate of 50 ml/min with an NP-KX-500 type large-volume pulseless pump manufactured by Nihon Seimitsu Kagaku Co., Ltd. into the poor solvent. At this time, the poor solvent was stirred at 500 rpm with a GK-0222-10 type Ramond Stirrer manufactured by Fujisawa Pharmaceutical Co., Ltd., and the temperature was controlled at 1° C.

Evaluation for each of the primary particle diameter, the ratio Mv/Mn, and the dispersion state was performed in the same manner as in Example 1. Table 8 shows the results.

[Table 8]

TABLE 8

| SDS | Particle | | | |
|---|---|---|---|---|
| concentration | diameter | | Dispersion | |
| (mass %) | (nm) | Mv/Mn | state | Note |
| 0 | 20 | 1.4 | 10.1 | Comparative example |
| 0.2 | 25 | 1.4 | 1.4 | Comparative example |
| 1.0 | 25 | 1.4 | 1.3 | Comparative example |

### Reference Example 1

A pigment solution was prepared by dissolving 530 mg of a pigment (Pigment Red 254) and 8 ml of a 1-mol/l aqueous solution of sodium hydroxide in 120 ml of 1-methyl-2-pyrrolidone. Separately, 1,000 ml of a solution, which contained 8 ml of 1-mol/l hydrochloric acid, was prepared as a poor solvent. Here, a pigment particle dispersion was prepared by injecting all of the thus-prepared pigment solution at a flow rate of 50 ml/min with an NP-KX-500 type large-volume pulseless pump manufactured by Nihon Seimitsu Kagaku Co., Ltd. into the poor solvent. At this time, the poor solvent was stirred at 500 rpm with a GK-0222-10 type Ramond Stirrer manufactured by Fujisawa Pharmaceutical Co., Ltd., and the temperature was controlled as shown in Table 9.

Evaluation for each of the primary particle diameter, the ratio Mv/Mn, and the dispersion state was performed in the same manner as in Example 1. Table 9 shows the results.

[Table 9]

TABLE 9

| Temperature of the | Particle | | Dispersion |
|---|---|---|---|
| poor solvent (° C.) | diameter (nm) | Mv/Mn | state |
| 1 | 20 | 1.4 | 10.1 |
| 25 | 35 | 1.6 | 6.3 |
| 60 | 70 | 1.9 | 5.8 |

### Reference Example 2

A pigment solution was prepared by dissolving 530 mg of a pigment (Pigment Red 254) and 8 ml of a 1-mol/l aqueous solution of sodium hydroxide in 120 ml of 1-methyl-2-pyrrolidone. Separately, 1,000 ml of a solution, which contained 8 ml of 1-mol/l hydrochloric acid, was prepared as a poor solvent. Here, a pigment particle dispersion was prepared by injecting the thus-prepared pigment solution at a flow rate of 50 ml/min with an NP—KX-500 type large-volume pulseless pump manufactured by Nihon Seimitsu Kagaku Co., Ltd. into the poor solvent. At this time, the poor solvent was stirred at the rotation rate as shown in Table 10 with a GK-0222-10 type Ramond Stirrer manufactured by Fujisawa Pharmaceutical Co., Ltd., and the temperature was controlled at 1° C.

Evaluation for each of the primary particle diameter, the ratio Mv/Mn, and the dispersion state was performed in the same manner as in Example 1. Table 10 shows the results.

[Table 10]

TABLE 10

| Stirring rate (rpm) | Particle diameter (nm) | Mv/Mn | Dispersion state |
|---|---|---|---|
| 500 | 20 | 1.4 | 10.1 |
| 300 | 30 | 1.6 | 9.5 |
| 100 | 50 | 2.1 | 7.8 |

### Example 8

To each of prepared pigment dispersions Examples (1) to (9), 500 ml of 2-(1-methoxy)propylacetate was added, and the mixture was stirred at 25° C. for 10 minutes at 500 rpm. After that, the resultant was left standing for 1 day so that pigment particles were extracted in a phase of the 2-(1-methoxy)propylacetate, to give a concentrated extract.

Each concentrated extract in which pigment particles were extracted was subjected to centrifugal separation with a high-speed centrifugal refrigerating machine HIMAC SCR20B manufactured by Hitachi Koki Co., Ltd at 3,500 rpm (2,000 g) for 1 hour. The resulting supernatant was discarded, whereby a pigment particle-concentrated liquid (having a pigment concentration of 15 mass %) was obtained.

In addition, each of pigment dispersions Examples (10) to (15) was subjected to centrifugal separation with a high-speed centrifugal refrigerating machine HIMAC SCR20B manufactured by Hitachi Koki Co., Ltd at 3,500 rpm (corresponding to a centrifugal force 2,000 times as large as gravitational acceleration) for 1 hour. The resulting supernatant was discarded, whereby a pigment particle concentrated liquid (having a pigment concentration of 15 mass %) was obtained.

Each of those liquids was re-dispersed with an ultrasonic cleaner W-103T manufactured by HONDA, and then the number average particle diameter of the resultant dispersion after concentration was determined as follows: the dispersion was dried on filter paper, the dried dispersion was photographed with a scanning electron microscope, and the particle diameters of 100 particles were measured. In addition, the ratio Mv/Mn was measured with a Nanotrac UPA-EX 150 manufactured by NIKKISO CO., LTD. Table 11 shows the results.

[Table 11]

TABLE 11

| | | | Particle | |
|---|---|---|---|---|
| | Particle diameter | | diameter after | |
| | before | Mv/Mn before | concentration | Mv/Mn after |
| | concentration (nm) | concentration | (nm) | concentration |
| This invention (1) | 20 | 1.4 | 20 | 1.4 |
| This invention (2) | 25 | 1.3 | 25 | 1.3 |
| This invention (3) | 30 | 1.3 | 30 | 1.3 |
| This invention (4) | 35 | 1.4 | 35 | 1.4 |
| This invention (5) | 50 | 1.4 | 50 | 1.4 |
| This invention (6) | 25 | 1.4 | 25 | 1.4 |
| This invention (7) | 45 | 1.4 | 45 | 1.4 |
| This invention (8) | 25 | 1.3 | 25 | 1.3 |
| This invention (9) | 35 | 1.3 | 35 | 1.3 |
| This invention (10) | 45 | 1.5 | 45 | 1.5 |
| This invention (11) | 60 | 1.5 | 60 | 1.5 |
| This invention (12) | 40 | 1.4 | 40 | 1.4 |
| This invention (13) | 55 | 1.5 | 55 | 1.5 |
| This invention (14) | 30 | 1.3 | 30 | 1.5 |
| This invention (15) | 35 | 1.3 | 35 | 1.5 |

The employment of the method of producing organic particles of the present invention made it possible to control the particle diameters of pigment particles with maintaining monodispersity of the particles. In addition, the employment enabled the concentration without changing the particle diameters and monodispersity of the particles. This shows that the method enables the production of an organic particle dispersion suitable for a color filter coating liquid or for ink-jet ink on an industrial scale.

With the method described in Comparative Example 1, it was impossible to change the particle diameters of particles. In addition, each of the method involving changing the poor solvent temperature described in Reference Example 1 and the method involving changing the stirring rate of the poor solvent described in Reference Example 2 made it possible to change the particle diameters of particles, but involved a problem that in addition to the particle diameter change, the monodispersity of the particles also changed.

The reagents used are specifically the followings:

| Reagent | Manufacturer |
|---|---|
| Pigment Red 254 (Irgaphore Red) | Ciba Specialty Chemicals company |
| 1-Methyl-2-pyrrolidone | Wako Pure Chemical Industries, Ltd. |
| Dimethylsulfoxide | Wako Pure Chemical Industries, Ltd. |
| Methanol | Wako Pure Chemical Industries, Ltd. |
| 2-(1-Methoxy) propyl acetate | Wako Pure Chemical Industries, Ltd. |
| 1-mol/l Aqueous solution of | Wako Pure Chemical Industries, Ltd. |
| sodium hydroxide | |
| 1-mol/l Hydrochloric acid | Wako Pure Chemical Industries, Ltd. |
| 8-mol/l Aqueous solution of | Wako Pure Chemical Industries, Ltd. |
| potassium hydroxide | |
| Sodium oleate | Wako Pure Chemical Industries, Ltd. |
| Sodium lauryl sulfate | Wako Pure Chemical Industries, Ltd. |
| ELEMINOL RS-30 | Sanyo Chemical Industries, Ltd. |

### INDUSTRIAL APPLICABILITY

According to the method of producing organic particles of the present invention, organic particles can be obtained under control of forming them in a desired particle size, even when the size is a nanometer sized, with maintaining monodispersity of the particles. In addition, a stable organic particle dispersion can be obtained, in which the organic particles do not aggregate even when time has passed.

The organic particles produced by the producing method of the present invention show nearly no changes in their particle diameter and monodispersity even when they are turned into a concentrated liquid, so they can be suitably used as ink-jet ink or raw material fine particles of the ink, or a color filter coating liquid or raw material fine particles of the liquid.

Having described our invention as related to the present embodiments, it is our intention that the invention not be limited by any of the details of the description, unless otherwise specified, but rather be construed broadly within its spirit and scope as set out in the accompanying claims.

This non-provisional application claims priority under 35 U.S.C. § 119 (a) on Patent Application No. 2005-136747 filed in Japan on May 9, 2005, and Patent Application No. 2005-213503 filed in Japan on Jul. 22, 2005, each of which is entirely herein incorporated by reference.

1. A method of producing organic particles, which comprises:
dissolving an organic material into a good solvent to form a solution; and
mixing the solution with a poor solvent for the organic material, in which the poor solvent is compatible with the good solvent, to form organic particles of the organic material in a liquid mixture,
wherein at least one selected from the group consisting of dispersing agent A and dispersing agent B is contained in the liquid mixture in which the organic particles are formed: dispersing agent A: an anionic surfactant having 14 or more carbon atoms, and dispersing agent B: a compound represented by formula (I), wherein A represents a component capable of forming an azo dye together with the X—Y; X represents a single bond or a group represented by —X¹—X²—; X¹ represents an arylene group having 6 to 20 carbon atoms; X² represents a divalent linking group selected from the group consisting of —CO—, —NR^{C}— (R^{C} represents an alkyl group having 1 to 5 carbon atoms, or a hydrogen atom), —O—, —S—, —SO—, —SO₂—, and a combination obtained from these groups; the arylene group represented by X¹ may be further substituted; Y represents a group represented by —Y¹—(Y²—Y³—NR₂)ₐ; Y¹ represents a divalent or trivalent aromatic group having 6 to 20 carbon atoms; Y² represents a group having the same meaning as that of X²; Y³ represents —{C(R¹¹)(R¹²)}ₖ—; R¹¹ and R¹² each represent a hydrogen atom or an alkyl group having 1 to 5 carbon atoms; k represents an integer of 1 to 10; the aromatic group represented by Y¹ may be further substituted; —NR² represents a lower alkylamino group, or a five- or six-membered saturated heterocyclic ring containing a nitrogen atom; and a represents 1 or 2.
A-N═N—X—Y [Chemical formula 1]
Formula (I)

2. The method of producing organic particles according to claim 1, wherein the organic particles have a number average particle diameter of 1 μm or less.

3. The method of producing organic particles according to claim 1, wherein the poor solvent for the organic material is a solvent selected from the group consisting of an aqueous solvent, an alcohol compound solvent, a ketone compound solvent, an ether compound solvent, an ester compound solvent, and a mixture of these solvents.

4. The method of producing organic particles according to claim 1, wherein the good solvent for the organic material is a solvent selected from the group consisting of an aqueous solvent, an alcohol compound solvent, a ketone compound solvent, an ether compound solvent, a sulfoxide compound solvent, an ester compound solvent, an amide compound solvent, and a mixture of these solvents.

5. The method of producing organic particles according to claim 1, wherein the dispersing agent is contained in a solvent at the time of the formation of the organic particles.

6. The method of producing organic particles according to claim 1, wherein the organic particles are organic pigment particles.

7. The method of producing organic particles according to claim 1,
wherein the at least one dispersing agent is a dispersing agent selected from the dispersing agent A, and
wherein the dispersing agent has no oxyethylene chain.
